(19) United States
(12) Patent Application Publication
(10) Pub. No.: US 2012/0297991 A1
(43) Pub. Date: Nov. 29, 2012

(54) HOT DOG AND SAUSAGE PREPARER

(76) Inventor: HOLLY HUESER, ST. CHARLES, IL (US)

(21) Appl. No.: 13/115,010

(22) Filed: May 24, 2011

(51) Int. Cl. A47J 43/04

(52) U.S. Cl. 99/547

(57) ABSTRACT

A food preparer for cutting hot dogs, sausages, and other elongated food products into bite-sized pieces. The preparer has a body formed to have a concavity that places an elongated food product in a predetermined location. The body includes a plurality of longitudinal slots that run generally perpendicular to the length of the food product. The body also has an end section with a hole having an axis that runs parallel with the length of the food product. A corer passes along the axis and cores the food product. A wire cutter pivots to pass wire through the slots and thus cut the food product. The result is cored, bite-sized pieces.

### FIELD OF THE INVENTION

The present invention is related to food preparation devices. More particularly the present invention is directed towards hot dog and sausage preparers that slice and core hot dogs, sausages, and other elongated food stuffs.

### BACKGROUND OF THE INVENTION

The hot dog is a quintessential American food. A hot dog, also known as the Frankfurter, is a type of sausage comprised of highly seasoned pork and/or beef that is cured, smoked, and cooked. While hot dogs are almost always sold fully cooked they are usually heated and served on a bun. However, hot dogs and sausages in general are sometimes cut into smaller pieces and added to other food products such as baked beans or casseroles.

While hot doges are enjoyed by people of all ages, they are particularly popular with children. Unfortunately and most regrettably, children often choke on elongated food stuffs such as hot dogs, sausages, pickles and cheese sticks. A major problem is that children have a smaller esophagus than adults and tend to choke more often on their food. While choking is, thankfully, usually a minor inconvenience it can and has caused serious injuries and even death. Complicating the problems of children choking on food products such as hot dogs and other sausages is that children do not always chew their food sufficiently and tend to stuff their mouths. The elongated shape of a hot dog lends itself to excessively large bites and mouth stuffing. These factors can significantly increase the incidents of choking.

One widely accepted method of reducing choking is to cut food into small, manageable pieces. This approach to reducing choking is not always easy to do with hot dogs, sausages, and other elongated food products. A major problem with those food products is that they are not directly geared to children in that they tend to have diameters suitable for adult consumption. So cutting into small pieces is only effective if the hot dog or sausage is cut such that the pieces cannot readily lodge in a child's throat. This requires forming hot dogs or sausages both laterally, to make short pieces, and longitudinally to make pieces that will not lodge in a throat. While this is not particularly difficult for an adult to do once in a while, not doing it or doing it poorly, can have such dire consequences that any device that makes it easier to do or that ensures doing it properly is highly beneficial.

Unfortunately it is not always possible for a responsible adult to be present to cut up a hot dog or sausage. Busy parenting, neglectful parenting, absent parenting, and irresponsible adults can lead to some children having to prepare their own food. Having a child actually cut a hot dog or sausage into small pieces, either for themselves or other children, using a sharp blade may be more dangerous than the danger of choking. Therefore, a hot dog and sausage preparer that does not use sharp blades would be highly beneficial.

Additionally, cutting hot dogs or sausages into small pieces can become extremely tedious in situations such as schools, camps, and day care. Therefore, a hot dog and sausage preparer that quickly and easily cuts a hot dog or sausage would be highly beneficial.

Prior art hot dog and sausage cutter usually involved the use of a knife of some sort to cut the hot dogs and sausages into small pieces. While generally successful the results are not always optimal. The resulting hot dog or sausage pieces, while small enough to be safe, had no structural elements to hold or retain condiments. For example, mustard, relish, cheese and other condiments could only be lathered on. However, some “finger foods” can be filled with condiments. Therefore, a hot dog and sausage preparer that produces bite-sized pieces having fillable holes would be useful.

Accordingly, a hot dog and sausage preparer that quickly, easily, and safely cuts hot dogs and sausages into safe, bite-sized pieces would be useful. Also useful would be a hot dog and sausage preparer that produces safe, bite-sized pieces having structural features to hold condiments would be beneficial.

### BRIEF SUMMARY OF THE INVENTION

The principles of the present invention provide for hot dog and sausage preparers that quickly, easily, and safely cut hot dogs, sausages, and other elongated foods into safe, bite-sized pieces having structural features to can hold condiments.

Those principles are incorporated in a hot dog and sausage preparer having a body formed with a concavity that locates an elongated food product in a predetermined location. The body further includes a plurality of longitudinal slots that run generally perpendicular to the length of the food product. The body also has an end section with a hole having an axis that runs parallel with the length of the food product. A tubular corer passes along the axis to core the food product. The hot dog and sausage preparer further includes a wire cutter that pivots on a pivot mount. The wire cutter includes a plurality of wires that are located on a frame. As the wire cutter pivots on the pivot mount the wires pass through the slots and cut the food product. The result is cored, bite-sized pieces. The hot dog and sausage preparer further includes a rod that passes through the tubular corer to clean the corer.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a perspective view of a base of a hot dog preparer that is in accord with the principles of the present invention;

FIG. 2 is a perspective view of a hot dog preparer that is in accord with the principles of the present invention.

FIG. 3 is a perspective view of a corer tube and of a cleaning that are used in the hot dog preparer of FIG. 2; and

FIG. 4 illustrates hot dog pieces prepared by the hot dog preparer illustrated in FIG. 2 after using the corer illustrated in FIG. 3.

### DETAILED DESCRIPTION OF THE INVENTION

The presently disclosed subject matter now will be described more fully hereinafter with reference to the accompanying drawings in which one embodiment is shown. However, it should be understood that this invention may take many different forms and thus should not be construed as being limited to the embodiment set forth herein. In the figures like numbers refer to like elements throughout.

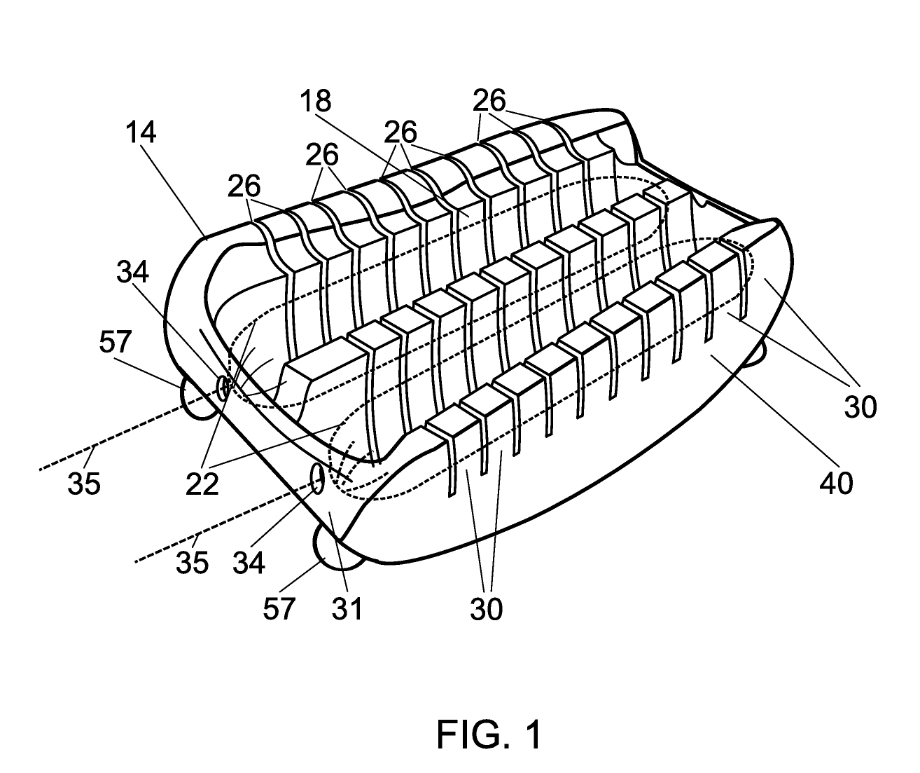

The principles of the present invention are described herein with reference to FIGS. 1 to 4. Those principles provide for preparers of hot dogs, sausages, and other elongated food stuffs and which produce bit-sized pieces having fillable holes. While the illustrated and described preparer is a hot dog preparer that produces 20 bit-sized pieces from two hot dogs at one time, preparers in accord with the present invention can be configured to work with other food products, to produce different numbers of bit-sized pieces from a given food product, and to produce bit-sized pieces from only one or even more than two food product at a time.

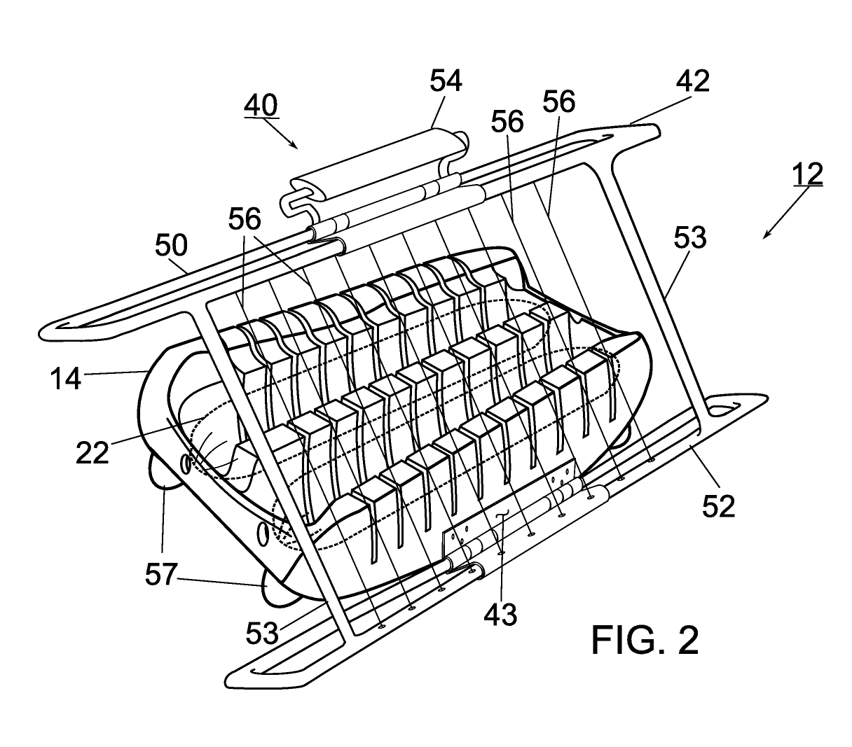

FIG. 1 illustrates a base 14 of a hot dog preparer 12 (see FIG. 2) that is in accord with the principles of the present invention. The base 14 has an upper surface 18 that is beneficially configured in the shape of two hot dog buns. The base 14 is suitable for receiving two hot dogs 22 and for retaining those hot dogs 22 in predetermined positions. The base 14 includes ten (10) lateral slots 26 which divide the base 14 and its upper surface 18 into sections 30. The base 14 further includes an end section 31 that has two longitudinal apertures 34. The base 14 is configured such that the predetermined positions of the hot dogs 22 are located such that the longitudinal centers of the hot dog 22 are located along the axes 35 of the apertures 34.

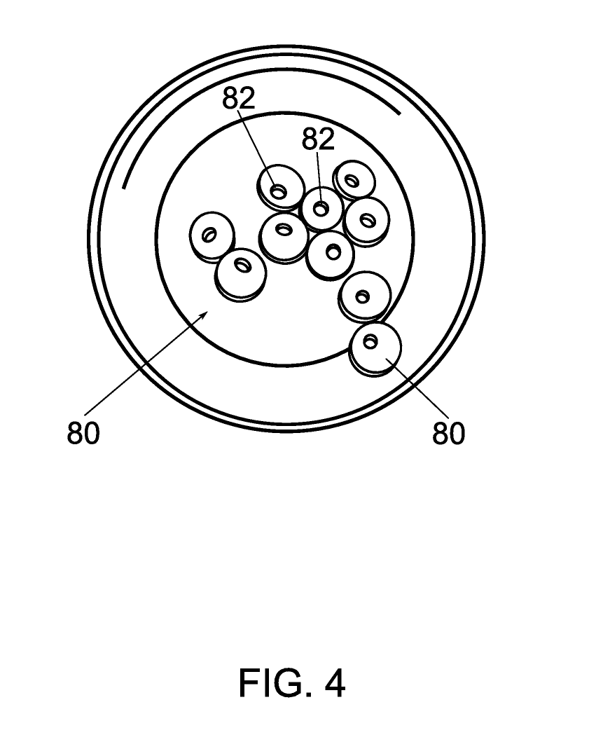

FIG. 2, illustrates the hot dog preparer 12 itself The hot dog preparer includes not only the base 14 but also a wire cutter 40 having a generally rectangular frame 42. The frame 42 forms a plane that is parallel with the axes 35 (see FIG. 2) of the apertures 34 of the base 14. The wire cutter 40 is pivotably mounted to the base 14 on a mount 43 that is located such that as the wire cutter 40 pivots the frame 42 remains parallel with the axes 35 (see FIG. 2) of the apertures 34. The frame 42 includes an upper member 50, a lower member 52, side members 53, and a handle 54. Disposed between the upper member 50 and the lower member 52 are ten (10) small, strong wires 56. The wires 56 are mounted and located on the wire cutter 40 such that pivoting the wire cutter 40 can cause the wires 56 to pass into the ten (10) slots 26 and cut through the hot dogs 22 so as to slice the hot dogs 22 into bite-sized pieces 80 (see FIG. 4). For stability, the hot dog preparer 12 further includes 4 small feet which are added to the bases 14.

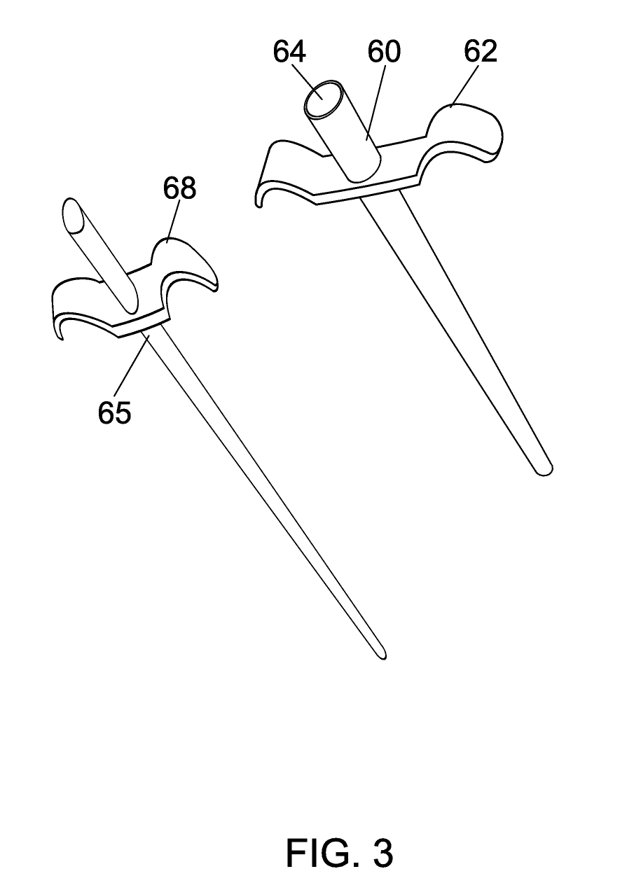

Referring now to FIG. 3, the hot dog preparer 12 further includes an elongated tubular corer 60 having a handle 62. The corer 60 has a hole 64 through the length of the corer 60. The length of the corer 60 is longer than a hot dog being prepared. Associated with the corer 60 is a solid rod 65 having a handle 68. The diameter of the solid rod 65 fits into the hole 64, while the length of the rod 65 is longer than the length of the corer.

In operation one or two hot dogs 22 are placed on the upper surface 18 of the base 14. The corer 60 is then inserted into an aperture 34 and pushed along the axis 35 through the hot dog 22. The corer 60 is then removed from the hot dog 22, leaving an aperture through the hot dog 22. If two hot dogs are being prepared the corer 60 is then inserted into the other aperture 34, along its axis 35, and the other hot dog 22 is similarly cored. The corer 60 is cleared by pushing the rod 65 through the hole 64. The handles 62 and 68 assist manipulating the corer 64 and rod 65, respectively.

After coring the hot dog(s) 22, the wire cutter 40 is pivoted such that the wires 56 pass into the slots 26 and through the hot dog or hot dogs 22, slicing them into bite sized pieces 80 (see FIG. 4). Those pieces 80 are then removed from the hot dog preparer 12, resulting in pieces 80 having holes 82 as shown in FIG. 4.

The pieces 80 are relatively thin while the cored holes 82 reduce the rigidity of the pieces 80. The combination of thinness and flexibility results in bite-sized pieces 80 of hot dog that can be safely eaten by children. The use of the wire cutter 40 in combination with the hot dog bun shaped upper surface 18 makes cutting the pieces 80 quick, safe and easy. If used in a setting where large numbers of pieces are required, such as schools or camps, multiple hot dogs 22 can be cut at a time. Furthermore, while the foregoing has described cutting hot dogs 22 the principles of the present invention are fully applicable to other food products such as sausages, pickles, cheese logs, etc. Additionally, it is possible to form the upper surface 18 such that other shapes can be readily cored and cut.

Most of the hot dog preparer 12 can be configured of metal or plastic. However, it is beneficial that the wires 56 are comprised of a strong metal such as spring steel. Additionally, it is beneficial that the feet 57 be comprised of a material such as rubber or polyurethane.

Therefore, it is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A food preparer for elongated food products, comprising:
a base having a body with an upper surface having a concavity configured to receive and to retain an elongated food product in a predetermined location relative to an axis that generally runs along the length of the elongated food product, said base further includes a plurality of spaced longitudinal slots that pass through said body, across said concavity, and that run generally perpendicular to said axis, said base further comprising an end section having a hole through said end section and aligned with said axis;
a corer comprised of an elongated tube dimensioned to pass through said hole and to pass along said axis such that said corer cores a food product on said upper surface;
a wire cutter having a frame that retains a plurality of cutting wires in predetermined spaced positions; and
a pivot mount attaching said wire cutter to said base;
wherein when said wire cutter pivots on said pivot mount said plurality of wires pass into said plurality of slots so as to cut an elongated food product on said upper surface into relatively thin bite-sized pieces.

2. A food preparer according to claim 1, wherein said concavity is shaped like a hot dog bun.

3. A food preparer according to claim 1, wherein said concavity is shaped like a sausage.

4. A food preparer according to claim 1, wherein passing said corer through said hole an along said axis prior to pivoting said wire cutter produced a cored bite-sized pieces.

5. A food preparer according to claim 1, wherein said upper surface includes a second concavity configured to receive and to retain an elongated food product.

6. A food preparer according to claim 1, wherein said wire cutter further includes a handle for assisting cutting.

7. A food preparer according to claim 1, further including a cleaning rod dimensioned to pass through said corer tube.
